(19) United States
(12) Patent Application Publication
(10) Pub. No.: US 2004/0201523 A1
(43) Pub. Date: Oct. 14, 2004

(54) Patch antenna apparatus preferable for receiving ground wave and signal wave from low elevation angle satellite

(75) Inventor: Dou Yuanzhu, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/811,635

(22) Filed: Mar. 29, 2004

(30) Foreign Application Priority Data
Apr. 9, 2003 (JP) 2003-105409

(51) Int. Cl. H01Q 1/38

(52) U.S. Cl. 343/700 MS

(57) ABSTRACT

A first ground-plane portion, on which an antenna element is disposed, is arranged above a second ground-plane portion with a predetermined distance therebetween. The first ground-plane portion operates as a parasitic antenna. The antenna element includes a dielectric substrate, a patch electrode provided on the top surface of the dielectric substrate, a ground electrode provided on substantially the entire bottom surface of the dielectric substrate, and current-feed pins that extend through the dielectric substrate and that are connected to the patch electrode. The first ground plane is defined by a conductor layer, which is provided on the top surface of a circuit board. The size of the ground-plane portion and the height of a support are appropriately set so that the first ground-plane portion is excited at a frequency that is substantially equal to a frequency at which the patch electrode is excited when current is fed.

### BACKGROUND OF THE INVENTION

1. Field of the Invention

The present invention relates to a patch antenna apparatus that is preferable for use as a vehicle-mounted small antenna or the like, and more particularly, to beam shaping of the radiation patterns of the patch antenna apparatus.

2. Description of the Related Art

Patch antennas are planar antennas in which a dielectric substrate having a patch electrode on the top surface is disposed on a ground-plane portion and a predetermined high-frequency current is fed to the patch electrode via current-feed pins or the like. The patch antennas are widely used as vehicle-mounted small antennas and the like for receiving satellite waves. In order for the patch antennas to achieve a high gain, the ground-plane portion needs to have a sufficiently large area compared to the patch electrode. Further, for stabilization of the performance of the patch antennas, many patch antennas have a configuration in which an opposing ground electrode is provided on the bottom surface of the dielectric substrate to be in contact with or in close proximity of the ground plane (e.g., Japanese Unexamined Patent Application Publication No. 6-224620, pp. 2-4, FIG. 1).

Typically, since the maximum radiation direction of the patch antennas is directly above the patch electrode, the patch antennas installed on, for example, the roof surfaces of vehicles can efficiently receive signal waves from a satellite located in the vicinity of the zenith.

However, the patch antennas having a maximum radiation direction at the zenith cannot efficiently receive ground waves. Thus, in a system in which a ground-based repeater receives signal waves from a satellite (e.g., an S-band digital audio radio satellite currently being planned) and re-transmits the signal waves, when such a known patch antenna is installed on the roof surface of a vehicle or the like, the antenna cannot be used as a planar antenna for receiving ground waves from the repeater. Consequently, a need arises for an antenna sticking up high, such as a pole antenna. Also, the antennas having the maximum radiation direction at the zenith are not suitable for receiving signal waves from a low elevation-angle satellite.

### SUMMARY OF THE INVENTION

The present invention has been made in view of the situations of the related art, and an object of the present invention is to provide a patch antenna apparatus that is preferable for receiving ground waves and signal waves from a low elevation-angle satellite.

To achieve the foregoing object, the present invention provides a patch antenna apparatus. In the patch antenna apparatus, a patch electrode is provided on the top surface of a dielectric substrate disposed above a first ground-plane portion and is connected to current-feed means. The first ground-plane portion is arranged above a second ground-plane portion, which has a larger area than the first ground-plane portion, with a predetermined distance therebetween. The first ground-plane portion is set so as to be excited by the second ground-plane portion at a frequency substantially equal to a frequency at which the patch electrode is excited when current is fed.

With this arrangement, the first ground-plane portion of the patch antenna apparatus serves as a parasitic antenna. Thus, a gain directly above the patch electrode is reduced and the beams are shaped so that the maximum radiation direction is at a low elevation angle. Appropriately setting the size of the first ground-plane portion and the distance between the first ground-plane portion and the second ground-plane portion allows the frequency of radio waves radiated from the patch electrode serving as a radiating conductor to substantially match the frequency of radio waves radiated from the first ground-plane portion serving as a radiating conductor. The maximum radiation direction of the radio waves radiated from the patch electrode serving as a radiating conductor is directly above, whereas the maximum radiation direction of the radio waves radiated from the first ground-plane portion serving as a radiating conductor is horizontal. Thus, a combined radiation pattern of both the radio waves has a flattened shape like a shape compressed from directly above. That is, this patch antenna apparatus has a reduced gain directly above the patch electrode and its maximum radiation direction changes from directly above the patch electrode to obliquely upward. Thus, even when installed on the roof surface of a vehicle or the like, this patch antenna apparatus can efficiently receive ground waves and signal waves from a low elevation-angle satellite.

A conductive layer may be provided on the top surface of a circuit board, which has a low-noise amplifier circuit at the bottom surface side thereof, so as to serve as the first ground-plane portion. This can preferably make effective use of the space between the first ground-plane portion and the second ground-plane portion.

### BRIEF DESCRIPTION OF THE DRAWINGS

FIG. 1 is a longitudinal sectional view of a patch antenna apparatus according to an embodiment of the present invention;

FIG. 2 is a plan view of the patch antenna apparatus; and

FIG. 3 is a graph showing the radiation pattern of the patch antenna apparatus of the embodiment in conjunction with a comparative example.

### DESCRIPTION OF THE PREFERRED EMBODIMENT

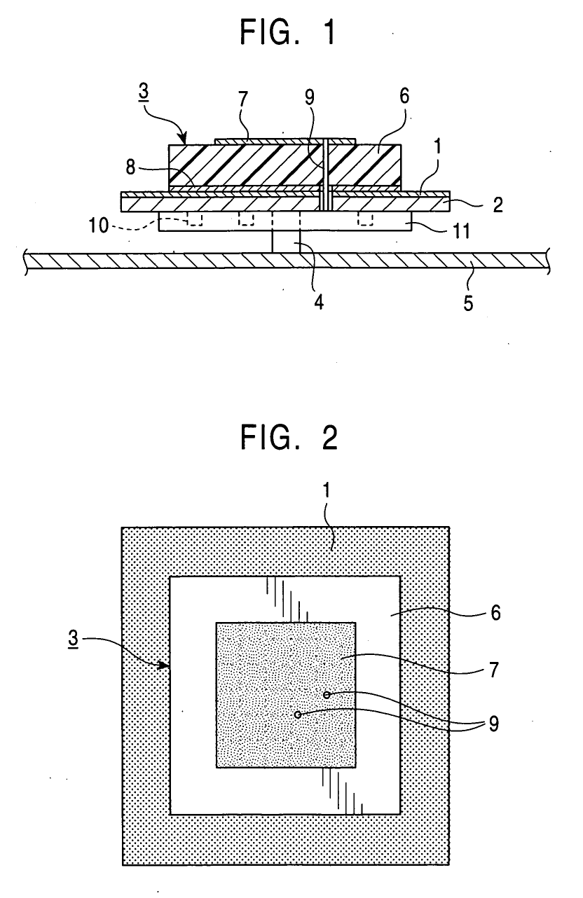

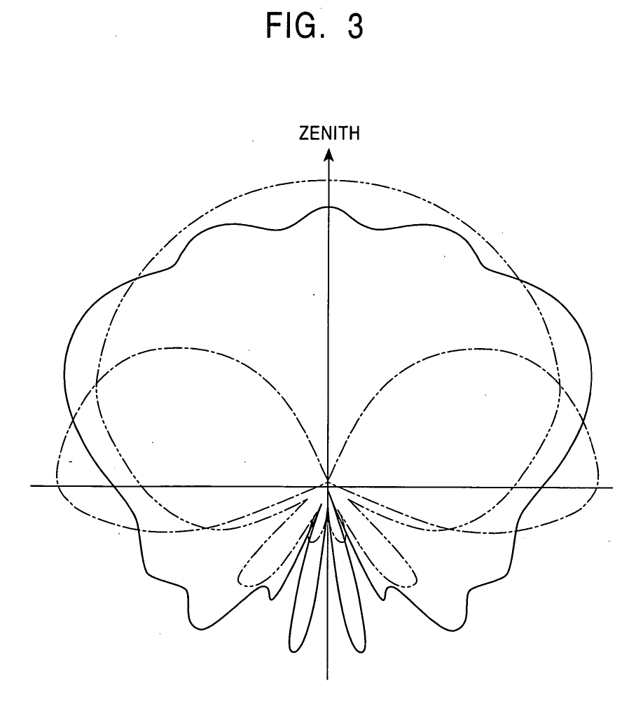

An embodiment of the present invention will now be described with reference to the accompanying drawings. FIG. 1 is a longitudinal sectional view of a patch antenna apparatus according to an embodiment of the present invention. FIG. 2 is a plan view of the patch antenna apparatus. FIG. 3 is a graph showing the radiation pattern of the patch antenna apparatus in conjunction with a comparative example.

The patch antenna apparatus shown in FIGS. 1 and 2 generally includes an antenna element 3 disposed on a circuit board 2 having a first ground-plane portion 1, a support 4 that supports the circuit board 2 and the antenna element 3, and a second ground-plane portion 5 that opposes the circuit board 2. The support 4 is set up on the second ground-plane portion 5. The second ground-plane portion 5 is preferably the metal body of a vehicle or the like.

The antenna element 3 includes a dielectric substrate 6, a patch electrode 7, a ground electrode 8, and current-feed pins 9. The dielectric substrate 6 is made of a dielectric material, such as a synthetic resin, and the patch electrode 7 is provided on the top surface of the dielectric substrate 6. The ground electrode 8 is provided on substantially the entire bottom surface of the dielectric substrate 6, and the current-feed pins 9 extend through the dielectric substrate 6 and are connected to the patch electrode 7. The current-feed pins 9 are also connected to a current-feed circuit, which is not shown, via the circuit board 2. In the embodiment, the relative dielectric constant εr of the dielectric material for use in the dielectric substrate 6 is expressed as the expression εr≈6. The patch electrode 7 has a 22×22 mm square shape. In order to receive circularly-polarized waves, the current-feed pins 9 are connected to appropriate two points of the patch electrode 7 and current is fed thereto via the two points. The dielectric substrate 6 is a rectangular plate, which has a square shape in plan view, and the square has a side length of 32 mm and a thickness of 6 mm.

The first ground-plane portion 1 is defined by a conductor layer, such as a copper sheet, provided on substantially the entire upper surface of the circuit board 2. A low-noise amplifier circuit 10 is arranged at the bottom surface side of the circuit board 2 to amplify a signal received from the antenna element 3. The low-noise amplifier circuit 10 is covered by a shield case 11. The support 4 is a metal member and is located below the center portion of the antenna element 3 to support the circuit substrate 2. The second ground-plane portion 5 is a conductor having a sufficiently large area in relation to the first ground-plane portion 1. In the case of the embodiment, the first ground-plane portion 1 is formed to have a 40×40 mm square shape. The antenna element 3 is placed at the center portion of the first ground-plane portion 1. The height of the support 4 is set such that the distance between the first ground-plane portion 1 and the second ground-plane portion 5 becomes 6 mm.

In the patch antenna apparatus configured as described above, when a predetermined high-frequency current is fed to the patch electrode 7 via the current-feed pins 9, the antenna element 3 radiates radio waves having a frequency f₀ (e.g., 2.338 GHz) with the patch electrode 7 serving as a radiating conductor. During the radiation, the first ground-plane portion 1 is excited by the second ground-plane portion 5, and radio waves having a frequency that is substantially equal to the frequency f₀ are radiated. That is, the size of the ground-plane portion 1 and the height dimension of the support 4 are set so that, when current is fed to the patch electrode 7 and the antenna element 3 radiates radio waves having the frequency f₀, the first ground-plane portion 1 operates as a parasitic antenna to radiate radio waves substantially equal to the frequency f₀. The radiation pattern of the radio waves radiated from the first ground-plane portion 1 serving as a radiating conductor has its maximum radiation direction in the horizontal direction as indicated by the dashed-dotted line in FIG. 3. In contrast, the maximum radiation direction of the radiation pattern of the radio waves radiated from the antenna element 3 is directly above (the zenith direction) as indicated by the long dashed double-short dashed line in FIG. 3. Thus, the actual radiation pattern, which is obtained by the combination of the two radiation patterns, has a flattened shape like a shape compressed from directly above, as indicated by the solid line in FIG. 3, and the maximum radiation direction thereof is obliquely upward (at an elevation angle of about 30°) from the patch electrode 7.

As described above, in the patch antenna apparatus according to the present embodiment, the first ground-plane portion 1, on which the antenna element 3 is disposed, is arranged above the second ground-plane portion 5, which has a larger area, with a predetermined distance therebetween. With this arrangement, the first ground-plane portion 1 operates as a parasitic antenna to thereby reduce the gain directly above the patch electrode 7. Thus, the beams are shaped so that the maximum radiation direction is at a low elevation angle. The patch antenna apparatus, therefore, can receive incoming signal waves even at an elevation angle of about 20°. Thus, even when installed on the roof surface of a vehicle or the like, this patch antenna apparatus can efficiently receive ground waves and signal waves from a low elevation-angle satellite, and thus can be used as a vehicle-mounted small antenna that is preferable for S-band radio broadcasting and the like.

As in the illustrated embodiment, when a conductive layer is provided on the top surface of the circuit board 2, which has the low-noise amplifier circuit 10 at the bottom surface side thereof, so as to serve as the first ground-plane portion 1, it is possible to make effective use of the space between the first ground-plane portion 1 and the second ground-plane portion 5 and is also possible to minimize the component count. Thus, such an arrangement is preferable.

While the description in the illustrated embodiment has been given of the case in which the dielectric substrate 6 and the patch electrode 7 have a square shape in plan view, the present invention is also applicable to a case in which they have a circular shape in plan view.

In addition, while current is fed via the two points to receive circularly-polarized waves in the illustrated embodiment, the present invention is not limited thereto. For example, the present invention is applicable to a case in which a recessed separating element is provided in the patch electrode 7 so that current is fed thereto via one point to receive circularly-polarized waves. The present invention is also applicable to a case in which linearly-polarized waves are received.

1. A patch antenna apparatus comprising: a patch electrode provided on a top surface of a dielectric substrate disposed above a first ground-plane portion and connected to current-feed means;
wherein the first ground-plane portion is arranged above a second ground-plane portion, which has a larger area than the first ground-plane portion, with a predetermined distance therebetween; and the first ground-plane portion is set so as to be excited by the second ground-plane portion at a frequency substantially equal to a frequency at which the patch electrode is excited when current is fed.

2. The patch antenna apparatus according to claim 1, wherein a conductive layer is provided on a top surface of a circuit board, which has a low-noise amplifier circuit at a bottom surface side thereof, so as to serve as the first ground-plane portion.
